(19) United States
(12) Patent Application Publication
(10) Pub. No.: US 2005/0068132 A1
(43) Pub. Date: Mar. 31, 2005

(54) System and method for connecting a removable coil to fixed coil terminals

(76) Inventors: Terry L. Marquardt, Brookfield, WI (US); Christian H. Passow, Enfield, NH (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/924,017

(22) Filed: Aug. 23, 2004

Related U.S. Application Data
(60) Provisional application No. 60/507,066, filed on Sep. 29, 2003.
(60) Provisional application No. 60/506,837, filed on Sep. 29, 2003.

(51) Int. Cl. H01H 67/02

(52) U.S. Cl. 335/202

(57) ABSTRACT

An electrical contactor has a removable coil comprising a contactor housing including a cavity. A pair of fixed coil terminals are mounted to the contactor housing proximate the cavity. A removable coil is removably mountable in the cavity. A pair of coil terminal clips are mounted to the coil. The fixed coil terminals make electrical contact with the coil terminal clips when the removable coil is inserted in the cavity.

### CROSS-REFERENCE TO RELATED APPLICATION

This application claims priority to, and incorporates by reference herein in its entirety, pending U.S. Provisional Patent Application Ser. No. 60/507,066 (Attorney Docket No. 2003P15061US), filed 29 Sep. 2003 and pending U.S. Provisional Patent Application Ser. No. 60/506,837 (Attorney Docket No. 2003P15050US), filed 29 Sep. 2003.

### FIELD OF THE INVENTION

The present invention relates to an electromechanical device having a removable coil and, more particularly, to a system and method for connecting a removable coil to fixed coil terminals.

### BACKGROUND OF THE INVENTION

A conventional electrical switching apparatus in one known form comprises an electromagnetically actuable device having a magnetic core proximate an armature. Typically, a coil is electrically energized to draw the armature to the magnetic core. The electromagnetically actuated device may be a control relay, a contactor, a motor starter and the like. The armature is operatively associated with a moveable device such as an actuator. With an electrical switching apparatus, the actuator operates a contact assembly.

The coil typically comprises a bobbin or the like carrying one or more windings. Opposite ends of the winding(s) are electrically connected to coil terminals fixedly mounted to the encapsulated coil. The coil terminals typically include screws for connecting wires to external control circuits that control operation of the device.

Some electrical switching apparatus include a removable coil. The coil might be removable to change voltage or if there has been coil burn out or the like. With a conventional removable coil, including integral fixed coil terminals, control wiring must first be removed prior to removal of the coil. Upon replacement of the coil, the terminal wiring must then be reconnected.

The present invention is directed to improvements in electromechanical devices.

### SUMMARY OF THE INVENTION

In accordance with the invention, there is provided a system and method for connecting a removable coil to fixed coil terminals.

Broadly, there is disclosed a system for connecting a removable coil to a fixed coil terminal in an electrical device. The system comprises a housing and a fixed coil terminal mounted to the housing. A removable coil is removably mountable in the housing. A coil terminal clip is mounted to the coil. The fixed coil terminal makes electrical contract with the coil terminal clip when the removable coil is inserted in the housing.

It is a feature of the invention that the coil terminal clip restrains movement of the removable coil in the housing.

It is another feature of the invention that the coil terminal clip comprises a clamp terminal that resiliently clamps to the fixed coil terminal. The clamp terminal may comprise an enlarged opening for aligning with the fixed coil terminal. The fixed coil terminal may comprise a planar blade. The clamp terminal can clamp against planar surfaces of the blade or peripheral edges of the blade.

It is a further feature of the invention that the coil terminal clip comprises a leaf spring.

It is another feature of the invention that the coil terminal clip comprises a bifurcated clip.

It is yet another feature of the invention that the fixed terminal comprises a spring loaded terminal for biasing against the coil terminal clip.

It is yet a further feature of the invention that the coil terminal clip comprises a spring.

There is disclosed in accordance with another aspect of the invention an electrical contactor having a removable coil comprising a contactor housing including a cavity. A pair of fixed coil terminals are mounted to the contactor housing proximate the cavity. A removable coil is removably mountable in the cavity. A pair of coil terminal clips are mounted to the coil. The fixed coil terminals make electrical contact with the coil terminal clips when the removable coil is inserted in the cavity.

There is disclosed in accordance with another aspect of the invention a method for connecting a removable coil to a fixed coil terminal in an electromechanical device comprising: providing a housing; extending a fixed coil terminal from the housing; providing a removable coil; extending a coil terminal from the coil; and inserting the removable coil into the housing wherein the coil terminal clip engages with and clamps on to the fixed coil terminal to electrically connect the removable coil to the fixed coil terminal.

Further features and advantages of the invention will be readily apparent from the specification and from the drawings.

### BRIEF DESCRIPTION OF THE DRAWINGS

FIG. 1 is a perspective view of a contactor having a removable coil in accordance with the invention;

FIG. 2 is a perspective view, similar to FIG. 1, illustrating installation of a coil and magnet in the contactor;

FIG. 3 is a perspective view of the coil and coil terminal clips prior to encapsulation;

FIG. 4 is a partial, perspective view illustrating the removable coil proximate fixed coil terminals prior to insertion;

FIG. 5 is a view similar to FIG. 4 illustrating the removable coil connected to the fixed coil terminals;

FIG. 6 is a partial perspective view illustrating the coil terminal clip of FIG. 3 with lead in edges to align the coil terminal to fixed terminals;

FIG. 7 is a partial perspective view similar to FIG. 6, illustrating a clamp terminal formed in a different orientation;

FIG. 8 is a partial perspective view illustrating a coil terminal in the form of a leaf spring;

FIG. 9 is a partial perspective view of an alternative embodiment illustrating a fixed terminal comprising a clamp terminal;

FIG. 10 is a perspective view of a fixed clamp terminal in a different orientation;

FIG. 11 is a partial perspective view illustrating a clamp terminal in yet another orientation with a coined fixed terminal;

FIG. 12 is a partial perspective view of a clamp terminal in a different orientation including lead in edges;

FIG. 13 is a partial perspective view of a clamp terminal comprising a trifurcated coil clip;

FIG. 14 is a partial perspective view similar to FIG. 11 with the clamp terminal in a different orientation;

FIG. 15 is a partial perspective view of a coil terminal clip as an integral part of a winding coil pin;

FIG. 16 is a perspective view illustrating a spring loaded fixed terminal;

FIG. 17 is a partial perspective view illustrating a compression spring coil terminal clip;

FIG. 18 is an elevation view of the device shown in FIG. 17;

FIG. 19 is a side view of the device illustrated in FIG. 17;

FIG. 20 is a partial perspective view illustrating a coil terminal clip in the form of a compression spring;

FIG. 21 is a plan view of the device of FIG. 20;

FIG. 22 is a partial perspective view of a fixed terminal comprising a coil spring; and

FIG. 23 is a plan view of the device of FIG. 22.

### DETAILED DESCRIPTION OF THE INVENTION

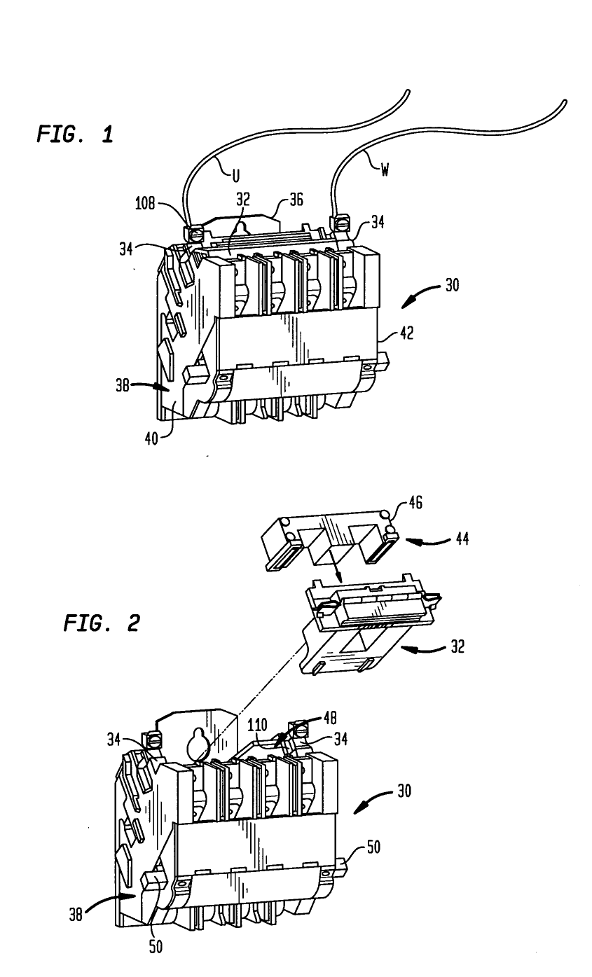

Referring to FIG. 1, an electrical device such as an electromechanical switching apparatus in the form of an electrical contactor 30 is illustrated. In accordance with the invention, the contactor 30 comprises a system and uses a method for connecting a removable coil 32 to a pair of identical fixed coil terminals 34.

The contactor 30 is an electromagnetically actuable device and includes a mounting plate 36 for mounting in a control panel or the like. A main housing 38 is mounted to the mounting plate 36. The main housing 38 includes a base 40 and cover 42. Referring also to FIG. 2, the main housing 38 comprises a cavity 48 receiving the removable electrical coil 32 and an associated electromagnet 44. The electromagnet 44 includes a magnetic core 46 and conventional armature (not shown). The armature is fixedly mounted in the cavity 48. The core 46 is inserted in the cavity 48 with the removable coil 32 to provide a functional electromagnet 44. As is conventional, energization of the coil 32 draws the armature to the magnetic core 46 for driving an actuator having opposite ends 50. Additionally, the main housing 38 encloses various electrical contacts (not shown) which can be opened or closed by the actuator 50 responsive to energization of the coil 32, as is conventional.

The present invention is not limited to the electrical contactor 30 illustrated herein. Instead, the present invention relates to a system and method for connecting the removable coil 32 to fixed coil terminals 34. This invention may be applied to at least electromechanical contactors, control relays and motor starters, as well as transformers and sensors, which may use removable coils.

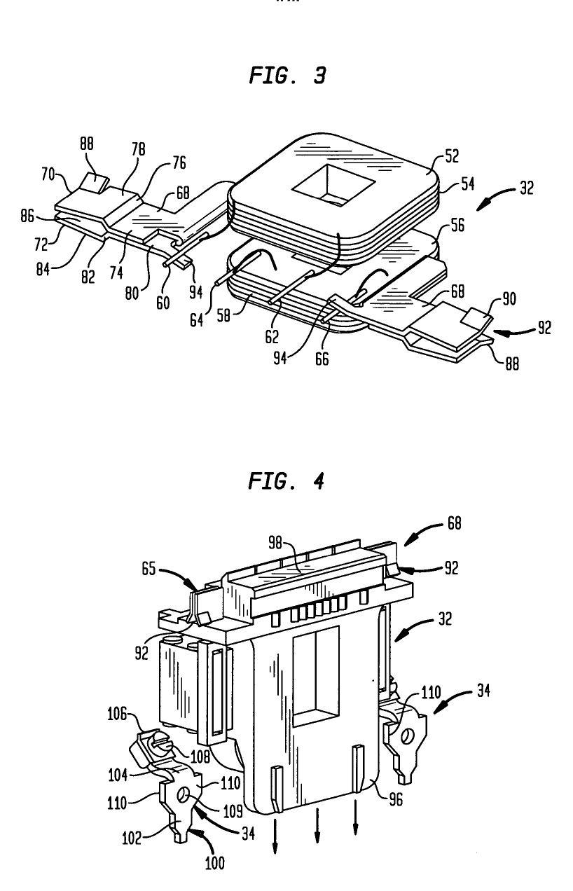

Referring to FIG. 3, the coil 32 is illustrated prior to encapsulation. The coil 32 comprises a first bobbin 52 having a first winding 54. A second bobbin 56 includes a second winding 58. Opposite ends of the first winding 54 are connected to a start pin 60 and finish pin 62. Opposite ends of the second winding 58 are connected to a start pin 64 and a finish pin 66. As will be appreciated, a one piece bobbin could be used for both windings 54 and 58. The pins are aligned as illustrated in the sequence 60, 64, 62 and 66. The first winding start pin 60 is connected, as by soldering or the like, to a coil terminal clip 68. The second winding finish pin 66 is similarly connected to another coil terminal clip 68. The coil terminal clips 68 connect to the fixed terminals 34, as described below, for connecting to an external control voltage source.

In an exemplary embodiment of the invention, each winding 54 and 58 could be designed to operate at 120 volts AC. If the windings 54 and 58 are connected in series by connecting the second winding start pin 64 to the first winding finish pin 62 a 240 volt AC coil is provided. Alternatively, if the windings 54 and 58 are connected in parallel by connecting the first winding start pin 60 to the second winding start pin 64 and the first winding finish pin 62 to the second winding finish pin 66, 120 volt AC operation is provided. As is apparent, different voltages could be used, as necessary or desired.

Although not shown, a slider may be provided for selecting coil voltage by providing the described connections as described in our copending application No. ______ filed concurrently with the present application and assigned to the assignee of the present invention, the specification of which is incorporated by reference herein (Attorney Docket No. 2003P15050US).

The two coil terminal clips 68 are identical in construction. This reduces the number of different parts. Only one is described in detail herein. Each coil terminal clip 68 comprises a first plate 70 and a second plate 72. The first plate 70 includes a planar portion 74 turned outwardly to a connecting portion 76 and then turned inwardly to a connecting portion 78. The second plate 72 similarly includes a planar portion 80 turned outwardly to a connecting portion 82 and then turned inwardly to a connecting portion 84. The planar portions 74 and 80 are mated with one another. As such, the connecting portions 78 and 84 define a space 86 therebetween which converges moving away from the planar portions 74 and 80 to define a clamp terminal for connecting to the fixed terminals 34. Each connecting portion 78 and 84 includes an outwardly turned tab 88 and 90, respectively, to provide a lead in edge 92 to align the coil terminal clip 68 to the fixed terminals 34. A tab 94 extends from the first piece planar portion 80 for connection to one of the winding pins 60 or 66, as illustrated.

FIG. 4 illustrates the coil 32 encapsulated in a plastic housing 96. The plastic housing 96 is in the form of a rectangular donut shape with the coil terminal clips 68 extending out opposite sides of the housing 96 with the lead in edges 92 opening away from a front wall 98 of the housing 96, as shown.

Each of the fixed terminals 34 is identical in construction. More particularly, the fixed terminal 36 is the same on both sides, reducing the number of different parts. Each fixed terminal 34 comprises a formed plate 100 of a conductive material, such as copper. The plate 100 includes a planar portion 102, connected to a turned portion 104 to a connecting portion 106. A screw 108 is fastened to the connecting portion 106 for receiving a wire W, see FIG. 1, for electrically connecting the coil 32 to an external control circuit. The planar portion 102 includes a through opening 109 for receiving a screw (not shown) for mounting the fixed terminal 34 to the main housing 38. A projecting portion, defining a blade 110, extends outwardly on either side of the opening 109. As described, each fixed terminal 34 can be fixedly mounted to the main housing 38, as shown in FIGS. 1 and 2, with one of the blades 110 from each fixed terminal 34 extending into the cavity 48. Particularly, the fixed terminals 34 are mounted so that spacing between the opposite blades 110 corresponds to spacing between the lead in edges 92 of the coil terminal clips 68.

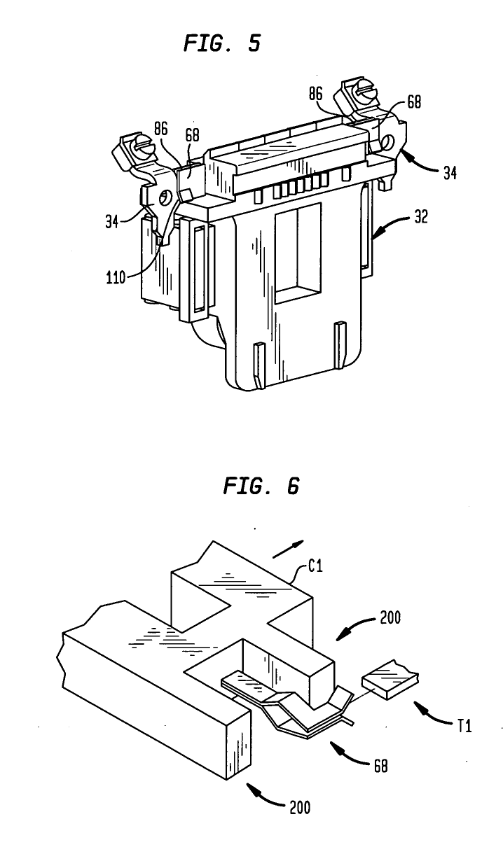

The removable coil 32 is inserted into the cavity 48 by moving it in the direction of the arrows shown in FIGS. 2 and 4 with the coil terminal clips 68 aligned with the fixed terminal blades 110. The lead in edges 92 align the coil terminal clips 68 to the fixed terminals 34 during insertion. When the removable coil 32 is fully inserted, as illustrated in FIGS. 1 and 5, the coil terminal clips 68 clamp onto the fixed coil terminal 34 to electrically connect the removable coil 32 to the fixed coil terminals 34 in the housing 38. More particularly, one of the blades 110 of each fixed coil terminal 34 is clamped in the space 86. When so inserted, the clamping pressure of the coil terminal clip 68 restrains movement of the removable coil 32 and thus retains the removable coil 32 in the cavity 48. The sliding cover (not shown), discussed above, can also be moved to lock the coil 32 in the cavity 48.

The present invention relates generally to a system and method for connecting a removable coil to a fixed coil terminal in an electrical device. FIGS. 1-5 illustrate one example of a configuration of a fixed coil terminal 34 and coil terminal clip 68. Various other embodiments are possible and several are illustrated in the figures and described below. For simplicity and clarity, in the following figures the encapsulated coil is illustrated in partial form and labeled C with a suffix number referencing a particular embodiment. Similarly, only a portion of the fixed coil terminal is illustrated and labeled T with the same suffix number. Also, for simplicity, only one side of the coil is illustrated, it being understood that the removable coil includes two coil terminal clips for mating with two fixed coil terminals.

Referring initially to FIG. 6, a coil C1 includes coil terminal clips 68 described above for mating with a fixed coil terminal T1. Ribs 200 extend from the coil C2 in front of and behind the coil terminal clip 68. The ribs 200 protect the coil terminal clip 68 from handling damage. The fixed terminal T1 is illustrated as a blunt edge blade.

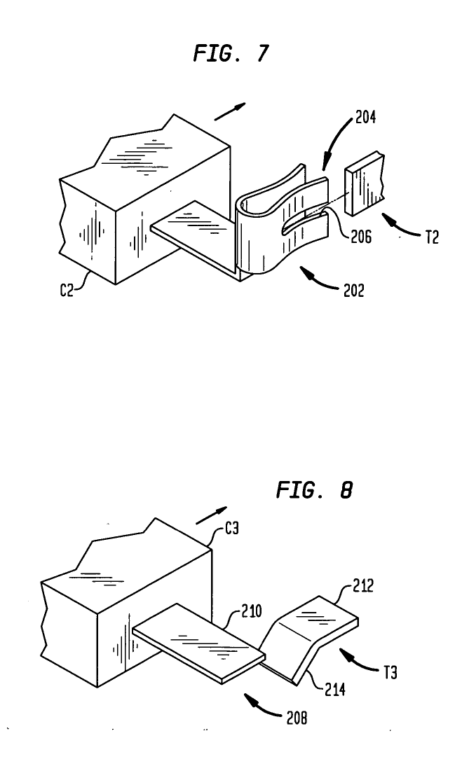

Referring to FIG. 7, a removable coil C2 includes a formed clamp terminal clip 202 to provide an opening 204 in a plane perpendicular to a main plane of the coil C2. The fixed coil terminal T2 is likewise in a similar perpendicular plane for being received in the opening 204. The clamp terminal clip 202 is formed of one piece construction and is bifurcated as at 206.

Referring to FIG. 8, a removable coil C3 includes a coil terminal clip 208 in the form of a planar leaf spring 210. A fixed coil terminal T3 includes a planar portion 212 and is bent downwardly at a distal end 214. As the removable coil C3 is inserted, as indicated by the arrow, the coil leaf spring 210 is forced against the fixed terminal distal end 214 along one face only. Although not shown, the leaf spring 210 will bias the removable coil C3 within the cavity 48 to restrain movement.

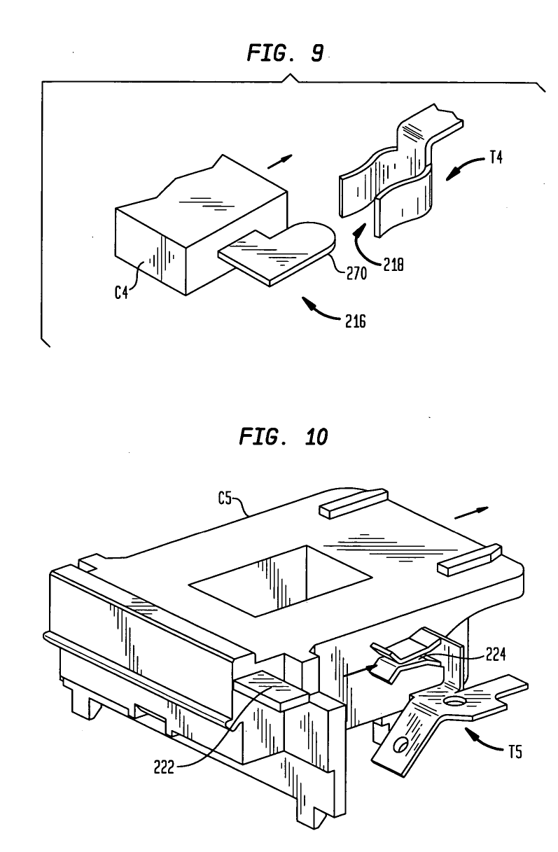

Referring to FIG. 9, a removable coil C4 includes a coil terminal clip in the form of a planar coil contact 216. A fixed coil terminal T4 comprises a dual sided clamp terminal 218. The clamp terminal 218 clamps against side edges 220 of the coil terminal clip 216 when the removable coil C4 is inserted, as by moving it in the direction of the arrow. This configuration is opposite the initial embodiment where the clamping terminal is mounted to the coil and the fixed terminal comprises a blade.

FIG. 10 illustrates a removable coil C5 including a coil terminal clip 222 in the form of a blade and a fixed coil terminal T5 including a clamp 224 oriented in a plane parallel to the main plane of the coil C5, opposite the orientation shown in FIG. 9. In this embodiment, the clamping terminal 224 clamps on planar surfaces of the coil terminal clip 222.

FIG. 11 illustrates a removable coil C6 including a coil terminal clip 226 in the form of a clamping terminal formed of two aligned trifurcated plates 28 opening upwardly. Because this design does not include a lead in edge for the coil terminal clip 226, a fixed coil terminal T6 includes a coined, sharp edge 230 for aligning with the coil terminal clip 226.

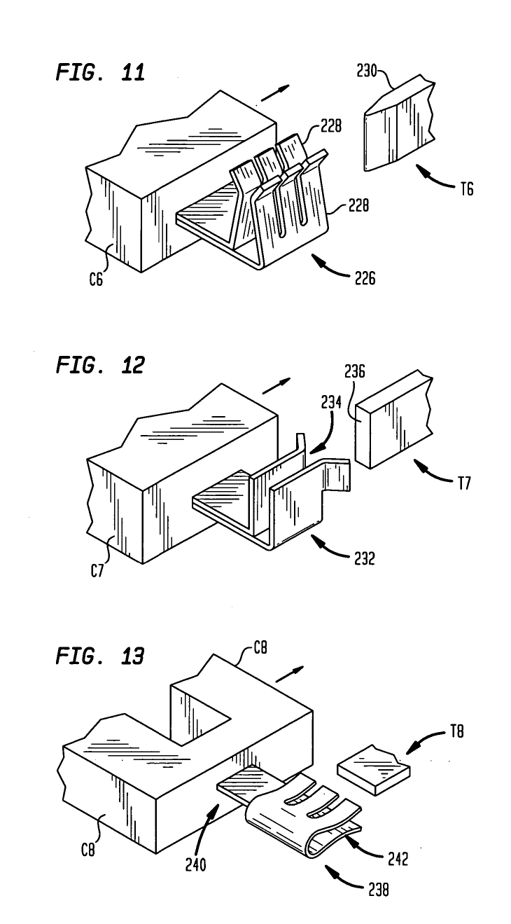

Referring to FIG. 12, a removable coil C7 includes a coil terminal clip 232 similar to that shown in FIG. 11, without trifurcation, and including a lead in edge 234 for receiving a blunt edge 236 of a fixed coil terminal T7.

Referring to FIG. 13, a removable coil C8 includes a coil terminal clip 238 having a single formed layer 240 protruding from the removable coil C8 and slotted and bent to define a clamping terminal 242 for receiving a blunt edge fixed coil terminal T8 in a plane generally parallel to a plane of the coil C8.

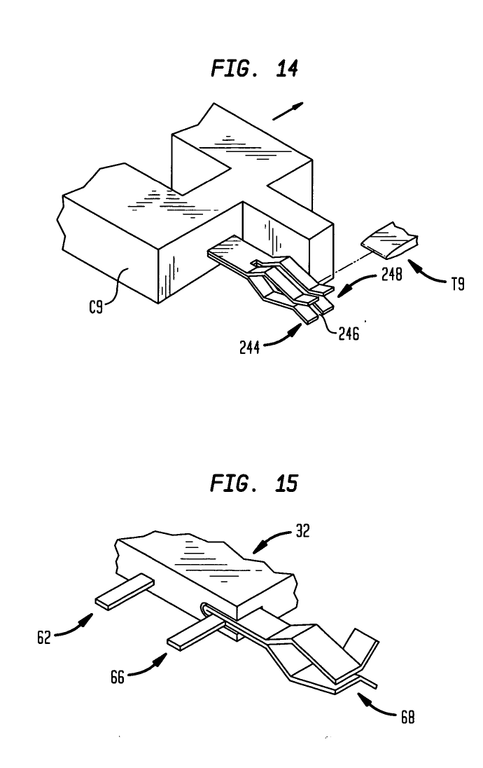

Referring to FIG. 14, a removable coil C9 includes a coil terminal clip 244, generally similar to the coil terminal clip 68, discussed above, except the coil clip is bifurcated as at 246 with an angled opening 248 directed away from the coil C9. This design includes no lead in edge and a coined fixed contact terminal T9 is utilized.

FIG. 15 illustrates the removable coil 32, discussed above, with the coil terminal clip 68. In this embodiment, the coil terminal clip 68 is integrally formed with the coil winding pin 66 (and likewise on the opposite end, not shown) inside the encapsulation. This eliminates the requirement to solder the coil terminal clip 68 to the winding pin 66 and reduces the number of parts to manufacture the electrical device.

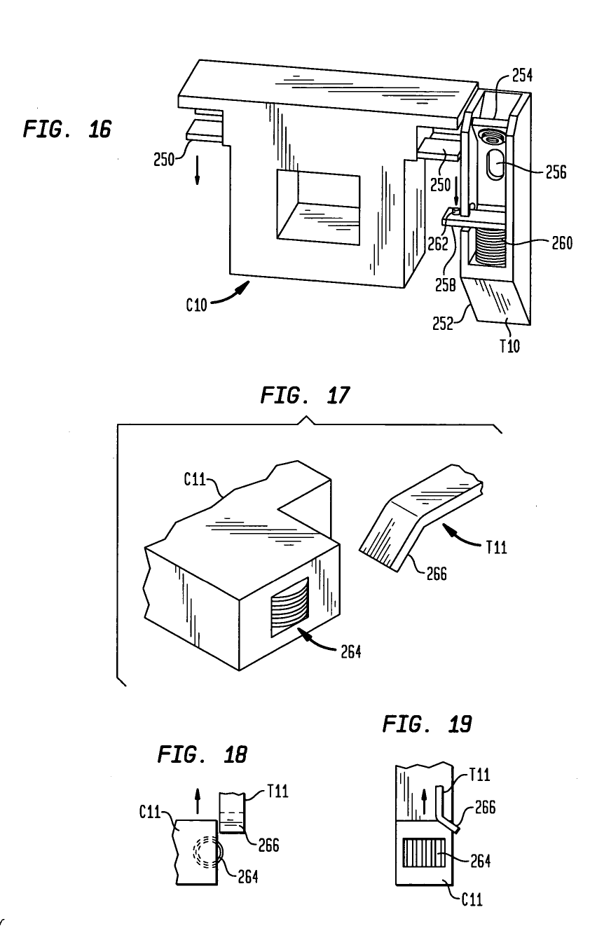

Referring to FIG. 16, an alternative embodiment of the invention is illustrated in the form of a removable coil C10 including coil terminal clips 250 in the form of a planar blade extending outwardly in a plane transverse to direction of movement of the coil C10 when inserted. A fixed coil terminal T10 comprises a housing 252 slidably receiving a conductive terminal 254. A mounting screw (not shown) is received in a slot 256 of the terminal 254 for holding the terminal 254 while sliding in the housing 252. A blade 258 extends outwardly from the housing 252 in a path of the coil terminal clip 250. A coil spring 260 is sandwiched between the housing 252 and the terminal blade 258. When the removable coil C10 is inserted, the coil terminal clip 250 makes electrical contact with the fixed terminal blade 258. The spring 260 provides force for good electrical connection and dampens coil vibrations. The spring 260 can also assist with coil removal. As is apparent, the housing 252 may be an integral portion of the main housing 38, discussed above. The fixed terminal contact plate 258 includes a contact pad 262 for electrically contacting the coil terminal clip 250, as is well known.

Referring to FIGS. 17-19, a removable coil C11 includes a coil terminal clip 264 in the form of a compression spring. The compression spring 264 internally makes contact with the winding (not shown). A fixed coil terminal T11 comprises a bent terminal. When the coil C11 is inserted, the compression spring 264 makes contact with the bent edge 266, as is apparent.

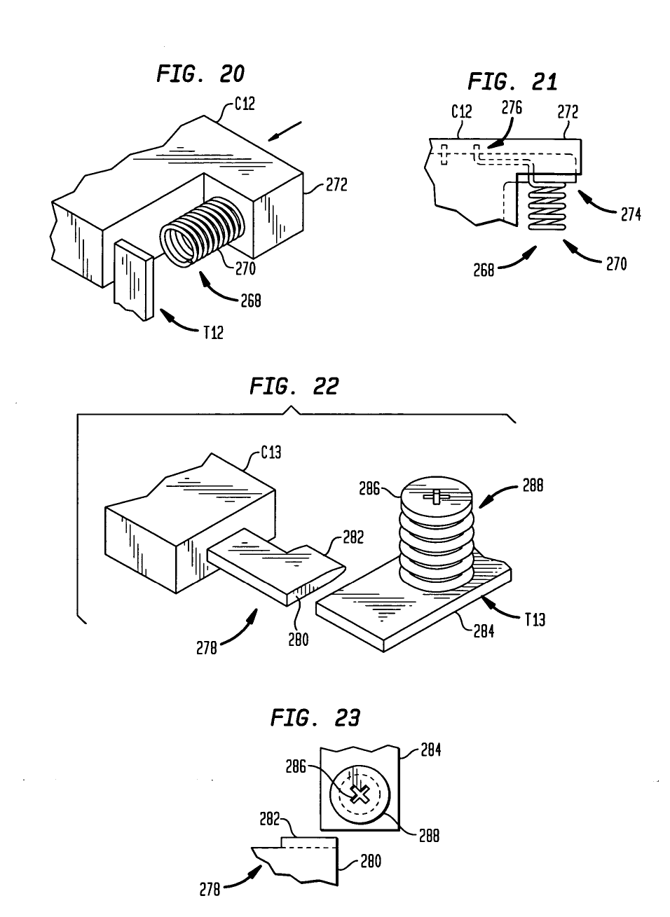

Referring to FIGS. 20 and 21, a removable coil C12 includes a coil terminal clip 268 in the form of a compression spring 270 which extends rearwardly from a rib 272. A bobbin 274 holds the spring 270 onto the rib 272. The spring 270 is wired as indicated in phantom at 276 to the internal winding. When the removable coil C12 is inserted, in a direction indicated by the arrow, the compression spring 270 is compressed against the fixed surface of the fixed coil terminal T12.

Finally, referring to FIGS. 22 and 23, a removable coil C13 includes a coil terminal clip 278 in the form of a blade contact 280 including a coined edge 282 facing rearwardly. A fixed coil terminal T13 comprises a plate 284 with a coil terminal screw 286 holding a spring 288 on the plates 284. When the coil terminal C13 is inserted, as by moving it in the direction of the arrow, the coined edge 282 is captured in the spring 288, as is apparent in the plan view of FIG. 23 so that the fixed terminal T13 makes electrical contact with the coil terminal clip 278.

Thus, in accordance with the invention, various embodiments are illustrated for the general concept of a system and method for connecting a removable coil to a fixed coil terminal. In each embodiment, control wiring is electrically connected to the fixed coil terminals. The removable coil can be removed and replaced without effecting the wiring.

1. A system for connecting a removable coil to a fixed coil terminal in an electrical device comprising:
a housing;
a fixed coil terminal mounted to the housing;
a removable coil removably mountable in the housing; and
a coil terminal clip mounted to the coil, wherein the fixed coil terminal makes electrical contact with the coil terminal clip when the removable coil is inserted in the housing.

2. The system of claim 1 wherein the coil terminal clip comprises a clamp terminal that resiliently clamps to the fixed coil terminal.

3. The system of claim 2 wherein the fixed coil terminal comprises a planar blade and the clamp terminal clamps against planar surfaces of the blade.

4. The system of claim 2 wherein the clamp terminal comprises an enlarged opening for aligning with the fixed coil terminal.

5. The system of claim 2 wherein the fixed coil terminal comprises a planar blade and the clamp terminal clamps against peripheral edges of the blade.

6. The system of claim 1 wherein the coil terminal clip comprises a leaf spring.

7. The system of claim 1 wherein the fixed coil terminal comprises a clamp terminal that resiliently clamps to the coil terminal clip.

8. The system of claim 1 wherein the coil terminal clip comprises a bifurcated clip.

9. The system of claim 1 wherein the fixed terminal comprises a spring loaded terminal for biasing against the coil terminal clip.

10. The system of claim 1 wherein the coil terminal clip comprises a spring.

11. An electrical contactor having a removable coil comprising:
a contactor housing including a cavity;
a pair of fixed coil terminals mounted to the contactor housing proximate the cavity;
a removable coil removably mountable in the cavity; and
a pair of coil terminal clips mounted to the coil, wherein the fixed coil terminals make electrical contact with the coil terminal clips when the removable coil is inserted in the cavity.

12. The electrical contactor of claim 11 wherein the coil terminal clips restrain movement of the removable coil in the cavity.

13. The electrical contactor of claim 11 wherein the coil terminal clips clamp to the fixed coil terminals to retain the removable coil in the cavity.

14. The electrical contactor of claim 11 wherein the coil terminal clips comprise clamp terminals that resiliently clamp to the fixed coil terminals.

15. The electrical contactor of claim 14 wherein the clamp terminals comprise an enlarged opening for aligning with the fixed coil terminals.

16. The electrical contactor of claim 11 wherein the coil terminal clips comprise leaf springs.

17. The electrical contactor of claim 14 wherein the fixed coil terminals comprise planar blades and the clamp terminals clamp against planar surfaces of the blades.

18. The electrical contactor of claim 11 wherein the fixed coil terminal comprise planar blades and the clamp terminals clamp against peripheral edges of the blades.

19. The electrical contactor of claim 11 wherein the coil terminal clips comprise bifurcated clips.

20. The electrical contactor of claim 11 wherein the fixed terminals comprise spring loaded terminals for biasing against the coil terminal clips.

21. The electrical contactor of claim 11 wherein the coil terminal clips comprise springs.

22. The electrical contactor of claim 11 wherein the fixed coil terminals are identical.

23. The electrical contactor of claim 11 wherein the coil terminal clips are identical.

24. The electrical contactor of claim 11 wherein the coil terminal clips are integral with coil pins of the removable coil.

25. A method for connecting a removable coil to a fixed coil terminal in an electromechanical device comprising:
providing a housing;
extending a fixed coil terminal from the housing;
providing a removable coil;
extending a coil terminal clip from the coil; and
inserting the removable coil into the housing wherein the coil terminal clip engages with and clamps onto the fixed coil terminal to electrically connect the removable coil to the fixed coil terminal.

26. The method of claim 25 wherein extending a coil terminal clip from the coil comprises providing an enlarged opening on the coil terminal clip for aligning with the fixed coil terminal.

27. The method of claim 25 wherein the fixed coil terminal comprises a planar blade and the coil terminal clip clamps against planar surfaces of the blade.

28. The method of claim 25 wherein the fixed coil terminal comprises a planar blade and the coil terminal clip clamps against peripheral edges of the blade.
